(19) United States
(12) Patent Application Publication
(10) Pub. No.: US 2017/0328291 A1
(43) Pub. Date: Nov. 16, 2017

(54) CONTROL APPARATUS FOR INTERNAL COMBUSTION ENGINE

(71) Applicant: TOYOTA JIDOSHA KABUSHIKI KAISHA, Toyota-shi (JP)

(72) Inventor: Hironori ITO, Susono-shi (JP)

(73) Assignee: TOYOTA JIDOSHA KABUSHIKI KAISHA, Toyota-shi (JP)

(21) Appl. No.: 15/589,241

(22) Filed: May 8, 2017

(30) Foreign Application Priority Data
May 11, 2016 (JP) 2016-095290

(51) Int. Cl. F02D 41/00; F02D 41/26; F02M 26/35; F02M 26/22; F02M 26/06

(52) U.S. Cl. CPC F02D 41/0077; F02D 41/26; F02M 26/06; F02M 26/22; F02D 2200/50; F02M 26/35

(57) ABSTRACT

An EGR passage, an EGR valve that is provided in the EGR passage, and an opening degree controller that controls an opening degree of the EGR valve based on an operating state of the internal combustion engine are included. The opening degree controller determines whether or not there is a possibility of an exhaust outlet of the exhaust passage being submerged in water, and when it is determined that there is the possibility of the exhaust outlet being submerged in water, the opening degree controller controls the opening degree of the EGR valve to a closing side as compared with a case where it is determined that there is no possibility of being submerged in a same operating state.

### FIELD

The present disclosure relates to a control apparatus for an internal combustion engine, and particularly relates to a control apparatus for an internal combustion engine including an exhaust gas recirculation device.

### BACKGROUND

Patent Literature 1, for example, discloses an internal combustion engine including an exhaust recirculation device (hereinafter, also referred to as an “EGR (Exhaust Gas Recirculation) device”) that recirculates exhaust gas after passing through a catalyst to intake air for the purpose of improving fuel efficiency. In an internal combustion engine equipped with an EGR device like this, it is necessary to control an amount of EGR in order to maximize a fuel improvement effect in accordance with an operation condition, and an EGR valve disposed in a passage for recirculating exhaust gas is used in the control.

Following is a list of patent literatures which the applicant has noticed as related arts of embodiments the present disclosure.
Patent Literature 1: JP 2010-150930 A
Patent Literature 2: JP 2013-162663 A
Patent Literature 3: JP 2005-069136 A

### SUMMARY

In an EGR device, exhaust gas is recirculated by using a pressure difference between an exhaust passage and an intake passage. Consequently, for example, when an exhaust outlet of the exhaust passage is submerged in water, exhaust gas more than necessary is recirculated into intake air due to increase in back pressure, and combustion is likely to be unstable.

The present disclosure is made in the light of the problem as described above, and has an object to provide a control apparatus that can restrain combustion instability due to submersion of an exhaust passage, in an internal combustion engine including an EGR device.

In order to attain the above described object, a first disclosure is a control apparatus for an internal combustion engine, including an EGR passage that connects between an intake passage and an exhaust passage of the internal combustion engine, an EGR valve that is provided in the EGR passage, and an opening degree controller that controls an opening degree of the EGR valve based on an operating state of the internal combustion engine, wherein the opening degree controller is programmed to determine whether or not there is a possibility of an exhaust outlet of the exhaust passage being submerged in water, and control the opening degree of the EGR valve to a closing side when it is determined that there is the possibility of the exhaust outlet being submerged in water, as compared with a case where there is no possibility of the exhaust outlet being submerged in water in a same operating state.

A second disclosure is, in the first disclosure, such that the opening degree controller is programmed to calculate running resistance of a vehicle that is loaded with the internal combustion engine, and determines that there is the possibility of the exhaust outlet being submerged in water when the running resistance is a threshold value or more.

A third disclosure is, in the first or the second disclosure, such that the opening degree controller is programmed to operate the opening degree of the EGR valve to full closure when it is determined that there is the possibility of the exhaust outlet being submerged in water.

According to the first disclosure, the EGR valve is operated to the closing side when it is determined that there is the possibility of the exhaust outlet of the exhaust passage being submerged in water. Thereby, EGR can be prevented from being excessive when the exhaust passage is submerged, and therefore, combustion can be restrained from becoming unstable.

According to the second disclosure, it is determined whether or not there is the possibility of the exhaust outlet being submerged in water depending on whether or not the running resistance of the vehicle which is loaded with the internal combustion engine is the threshold value or more. The running resistance of the vehicle increases as the submersion depth is larger. Consequently, the running resistance of the vehicle can be an index of whether or not the exhaust outlet of the exhaust passage is submerged in water. Consequently, according to the present disclosure, it becomes possible to determine a possibility of submersion of the exhaust passage with high precision.

According to the third disclosure, the EGR valve is operated to full closure when it is determined that there is the possibility of the exhaust passage being submerged in water. Thereby, recirculation of the exhaust gas to intake air can be completely stopped, and therefore, it becomes possible to reliably inhibit combustion instability at the time of the exhaust passage being submerged in water.

### BRIEF DESCRIPTION OF DRAWINGS

FIG. 1 is a diagram illustrating a schematic configuration of a system loaded with an internal combustion engine to which a control apparatus as a first embodiment of the present disclosure is applied;

FIG. 2 is a time chart illustrating changes of various state quantities at a time of a vehicle loaded with the engine being submerged in water;

FIG. 3 illustrates an example of an opening degree map of an EGR valve in ordinary EGR control;

FIG. 4 illustrates an example of an opening degree map of the EGR valve in EGR control at a time of submersion; and

FIG. 5 is a flowchart illustrating a control routine that is executed by an ECU in the first embodiment of the present disclosure.

### DETAILED DESCRIPTION

### First Embodiment

A first embodiment of the present disclosure will be described with reference to the drawings.

[Configuration of First Embodiment]

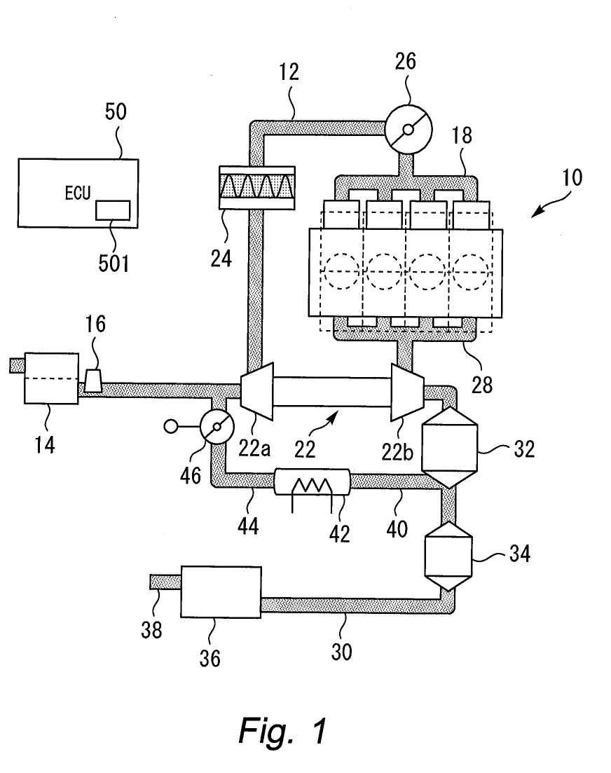

FIG. 1 is a diagram illustrating a schematic configuration of a system loaded with an internal combustion engine (hereinafter, simply referred to as an engine) to which a control apparatus as the first embodiment of the present disclosure is applied. An engine 10 illustrated in FIG. 1 is a spark-ignition type four stroke reciprocating engine and is loaded on a vehicle. The engine 10 has configurations of an intake system for supplying air into combustion chambers of respective cylinders, an exhaust system for exhausting exhaust gas, an EGR system that recirculates a part of the exhaust gas of the exhaust system to the intake system, and a control system for controlling an operation of the engine 10. Hereinafter, the configurations will be respectively described in detail.

The intake system of the engine 10 includes an intake passage 12. An air cleaner 14 is mounted to an inlet port side of the intake passage 12. An air flow meter 16 that outputs a signal corresponding to a flow rate of air that is taken into the intake passage 12 is mounted to a downstream side of the air cleaner 14 in the intake passage 12. An outlet port side of the intake passage 12 is connected to the combustion chambers of the respective cylinders via an intake manifold 18.

A compressor 22a of a turbocharger 22 is disposed at a downstream side of the air flow meter 16 in the intake passage 12. An intercooler 24 for cooling intake air that is compressed by the compressor 22a is disposed in the intake passage 12 at a downstream side of the compressor 22a. A throttle valve 26 for adjusting an amount of air that is supplied into the engine 10 is disposed in the intake passage at a downstream side of the intercooler 24.

The exhaust system of the engine 10 includes an exhaust passage 30. One end side of the exhaust passage 30 is connected to the combustion chambers of the respective cylinders via an exhaust manifold 28. A turbine 22b of the turbocharger 22 is disposed midway in the exhaust passage 30. In the exhaust passage 30 at a downstream side of the turbine 22b, an upstream side catalyst 32 and a downstream side catalyst 34 are disposed in this sequence. Further, a muffler 36 for silencing noise is disposed in the exhaust passage 30 at a downstream side of the downstream side catalyst 34. An exhaust outlet 38 of the exhaust passage 30 is opened rearward of the vehicle in a position at a predetermined height from the ground.

Further, the EGR system of the engine 10 includes an EGR passage 40. One end of the EGR passage 40 is connected to the exhaust passage 30 between the upstream side catalyst 32 and the downstream side catalyst 34, and the other end is connected to the intake passage 12 between the air flow meter 16 and the compressor 22a. Midway in the EGR passage 40, an EGR cooler 42 for cooling EGR gas, an EGR filter 44 for removing fine particles in the EGR gas and an EGR valve 46 for opening and closing the EGR passage 40 are provided in sequence from a communication side with the exhaust passage 30.

The engine 10 of the present embodiment includes an ECU (Electronic Control Unit) 50 as the control system thereof. The ECU 50 includes at least an input/output interface, a memory and a CPU (processor). The input/output interface is provided to take in sensor signals from various sensors mounted to the internal combustion engine, and output operation signals to actuators included by the internal combustion engine. The sensors from which the ECU 50 takes in signals include various sensors necessary to control the internal combustion engine, such as a crank angle sensor and an accelerator position sensor in addition to the aforementioned air flow meter 16. The actuators to which the ECU 50 issues the operation signals include various actuators such as the throttle valve 26 and the EGR valve 46 described above. In the memory, various control programs for controlling the internal combustion engine, maps and the like are stored. The CPU (processor) reads the control program or the like from the memory and executes the control program or the like, and generates operation signals based on the sensor signals which are taken in.

[Operation of First Embodiment]

Next, an operation of the first embodiment will be described with reference to the drawings. As illustrated in FIG. 1, the engine 10 of the present embodiment includes an EGR device that recirculates a part the exhaust gas that has a pressure reduced by passing through the upstream side catalyst 32 to the intake system, for the purpose of improving fuel efficiency or the like. The EGR device is mainly configured by the EGR passage 40, the EGR valve 46 and an opening degree controller 501 that controls an opening degree of the EGR valve 46. The opening degree controller 501 is a part of a processing circuit of the ECU 50, and is for realizing a function of adjusting a ratio of the exhaust gas that is recirculated to the intake passage 12. The opening degree of the EGR valve 46 is stored in the opening degree controller 501 by being associated with an operation condition that is set by an engine speed and engine torque. Thereby, an EGR rate for maximizing a fuel improvement effect is configured to be realized in accordance with an operating state.

Here, the EGR gas that passes through the EGR passage 40 is introduced into the intake passage 12 by using a pressure difference between a pressure of the exhaust passage 30 between the upstream side catalyst 32 and the downstream side catalyst 34, and a pressure of the intake passage 12 between the air cleaner 14 and the compressor 22a. Consequently, when the exhaust outlet 38 of the exhaust passage 30 is submerged in water, there arises the risk that a recirculation amount of the EGR gas becomes excessively large due to increase in the pressure of the exhaust passage 30 and combustion becomes unstable. Thus, in the system of the first embodiment, in the case where water is likely to enter from the exhaust outlet 38, the EGR valve 46 is operated to a closing side more than a normal time in the same operating state. Hereinafter, an opening degree control method for the EGR valve 46 at the time of submersion of the exhaust outlet 38 will be described in detail.

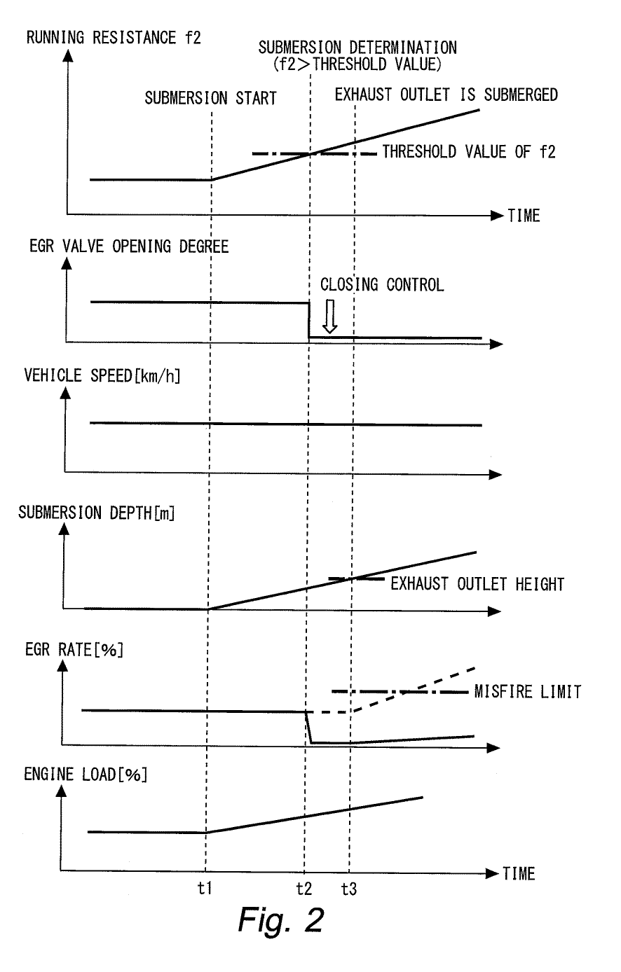

FIG. 2 is a time chart illustrating changes of various state quantities at a time of the vehicle loaded with the engine 10 being submerged in water. In FIG. 2, a chart in a first tier illustrates a change with time of running resistance f₂ of the vehicle, and a chart in a second tier illustrates a change with time of an EGR valve opening degree. A chart in a third tier illustrates a change with time of a vehicle speed of the vehicle, and a chart in a fourth tier illustrates a change with time of a submersion depth of the vehicle. A chart in a fifth tier illustrates a change with time of the EGR rate, and a chart in a sixth tier illustrates a change with time of an engine load, respectively.

The chart illustrated in FIG. 2 illustrates a case where submersion of the vehicle is started at a time point t1, and the submersion depth becomes larger with time. The running resistance f₂ in the chart in the first tier is resistance that is proportional to a square of a speed of the vehicle, and includes resistance of water and resistance of air. At the time point t1 and the following time points, the resistance of water increases as the submersion depth becomes larger, and therefore, the running resistance f₂ increases with this. Further, in the chart illustrated in FIG. 2, an engine load at the time point t1 and the following time points increases to keep the vehicle speed in this period constant.

When the time reaches a time point t3 at which the submersion depth becomes a height of the exhaust outlet 38, a back pressure increases by entry of water from the exhaust outlet 38. When normal control of the EGR valve 46 is continued at this time, there arises the risk that the EGR rate increases as illustrated by a dotted line in the chart in the fifth tier, and combustion of the engine 10 reaches a misfire limit.

Thus, in the system of the first embodiment, the opening degree of the EGR valve 46 is operated to a closing side at a time point t2 before the time point t3 at which the exhaust outlet 38 is submerged in water. According to the control like this, the EGR rate can be reduced at the time point t2 as illustrated by a solid line in the chart in the fifth tier, and therefore, even if the back pressure increases at the time point t3 thereafter, it becomes possible to restrain combustion instability due to excessive EGR.

Note that a timing of the time point t2 corresponds to a timing when there is a possibility of the exhaust outlet 38 being submerged in water. As described above, the running resistance f₂ becomes larger as the submersion depth becomes larger. Consequently, the running resistance f₂ in a case of being immediately before the submersion depth reaches a height of the exhaust outlet 38 is specified as a threshold value in advance by an experiment or the like, and it can be determined whether or not there is the possibility of the exhaust outlet 38 being submerged in water, depending on whether or not the running resistance f₂ exceeds the threshold value.

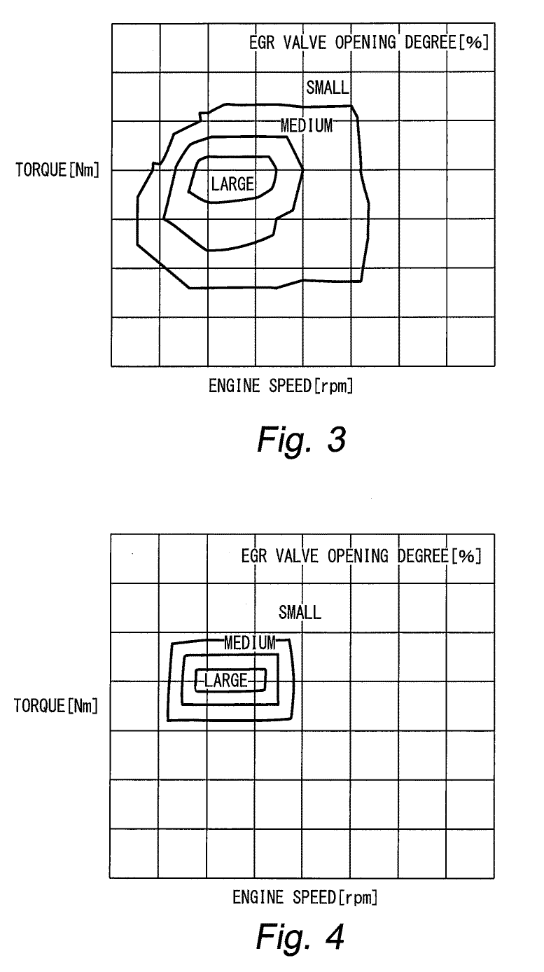

Further, although various methods are conceivable as a method for operating the opening degree of the EGR valve 46 to the closing side when submersion is determined, the method can be realized by switching the opening degree map of the EGR valve 46, for example. FIG. 3 illustrates an example of an opening degree map of the EGR valve in normal EGR control. Further, FIG. 4 illustrates an example of an opening degree map of the EGR valve in EGR control at a time of submersion. The maps illustrated in FIG. 3 and FIG. 4 are stored with the EGR valve opening degrees being associated with engine speeds and engine torques. In the map illustrated in FIG. 4, the EGR valve opening degree under the same operation conditions is set at a smaller opening degree than in the map illustrated in FIG. 3. Consequently, if the map is switched from the map illustrated in FIG. 3 to the map illustrated in FIG. 4 when it is determined that there is a possibility of submersion in the opening degree control of the EGR valve, it becomes possible to shift the opening degree of the EGR valve 46 to an opening degree at the closing side before the exhaust outlet 38 is submerged in water.

Respective function of the opening degree controller 501 in the ECU 50 are realized by a processing circuitry. That is, the ECU 50 includes the processing circuitry for determining whether or not there is a possibility of an exhaust outlet 38 of the exhaust passage 30 being submerged in water, and controlling the opening degree of the EGR valve 46 to a closing side when it is determined that there is the possibility of the exhaust outlet 38 being submerged in water, as compared with a case where there is no possibility of the exhaust outlet 38 being submerged in water in a same operating state. The processing circuitry is the CPU (Central Processing Unit, also referred to as a central processing device, a processing device, an arithmetic operation device, a microprocessor, a microcomputer, a processor, and a DSP) that executes the programs stored in the memory.

The function of the opening degree controller 501 are realized by software, firmware, or a combination of software and firmware. The software and the firmware are described as programs, and are stored in the memory. The processing circuitry realizes the functions of the opening degree controller 501 by reading the programs stored in the memory and executing the programs. That is, when the opening degree controller 501 is realized by a processing circuitry, the controller includes the memory for storing the program by which a step of determining whether or not there is a possibility of an exhaust outlet 38 of the exhaust passage 30 being submerged in water, and a step of controlling the opening degree of the EGR valve 46 to a closing side when it is determined that there is the possibility of the exhaust outlet 38 being submerged in water, as compared with a case where there is no possibility of the exhaust outlet 38 being submerged in water in a same operating state. The processing circuitry realizes the function of the opening degree controller 501 by reading the programs stored in the memory and executing the programs, and/or by specifically configured hardware (e.g., one or more application specific integrated circuits (ASICs)) included in the processing circuitry. Here, a nonvolatile or volatile semiconductor memory such as a RAM, a ROM, a flash memory, an EPROM, or an EPPROM corresponds to the memory.

[Specific Processing in First Embodiment]

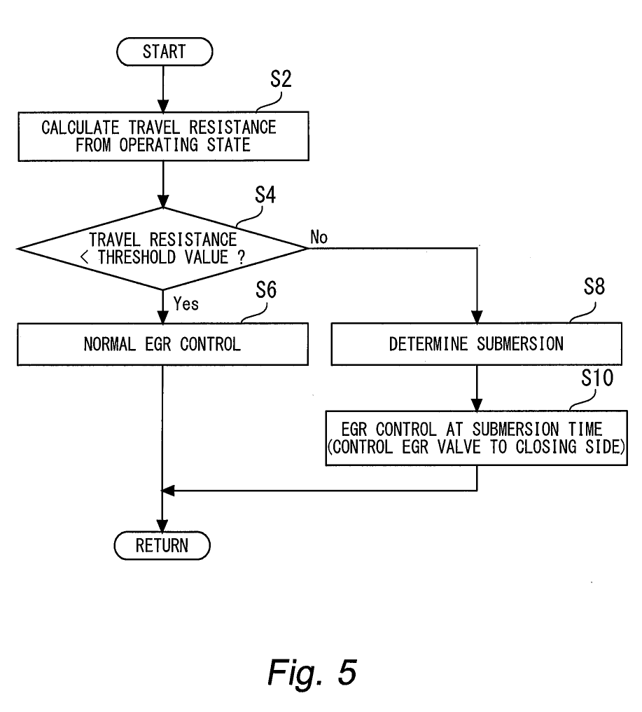

Next, specific processing of the opening degree control of the EGR valve 46 that is executed in the system of the first embodiment will be described with reference to FIG. 5. FIG. 5 is a flowchart illustrating a control routine that is executed by the ECU 50 in the present embodiment. Note that the routine illustrated in FIG. 5 is repeatedly executed at predetermined control periods during an operation of the engine 10.

In the control routine illustrated in FIG. 5, the running resistance f₂ of the vehicle is calculated based on the operating state of the engine 10 first (step S2). Here, more specifically, the running resistance f₂ is calculated in accordance with expression (1) as follows. In expression (1) as follows, “M” represents a weight [Kg], “v” represents a vehicle speed [m/s], “a” represents an acceleration of the vehicle [m/s²], Ft represents a force [N] that is transmitted to the ground from tires of the vehicle, “g” represents a gravitational acceleration [m/s²], θ represents an inclination angle [rad] of the vehicle, f₁ represents resistance [N] that occurs irrespective of the speed, f₂ represents resistance [N·s²/m²] that is proportional to the square of the speed, Te represents engine torque [Nm], Nt represents a rotational speed [rpm] of the tires of the vehicle, and Ne represents an engine speed [rpm]. Each value can be obtained from a detection value of a sensor known to the public, or a design value or an experimental value that is stored in advance.

$$\begin{matrix}[ Expression 1 ] & \\ Ma = {F}_{t} - Mg sin θ - {f}_{1} - {f}_{2} {v}^{2} \\ {F}_{t} = \frac{Te}{\frac{Nt}{Ne}} \div r & ( 1 )\end{matrix}$$

Next, it is determined whether or not the calculated running resistance f₂ is smaller than the threshold value (step S4). The ECU 50 stores the value of the running resistance f₂ in the case of the submersion depth being immediately before reaching the height of the exhaust outlet 38 as the threshold value. Here, the threshold value that is stored in the ECU 50 is read, and is compared with the running resistance f₂ calculated in step S2. When establishment of the running resistance f₂<threshold value is recognized as a result, it is determined that there is no risk of the submersion depth reaching the height of the exhaust outlet 38, the flow shifts to the next step, and normal EGR control is performed (step S6). Here, more specifically, EGR control using the map illustrated in FIG. 3 is performed.

Meanwhile, when establishment of the running resistance f₂<threshold value is not recognized in step S4 described above, submersion depth is determined as being immediately before reaching the height of the exhaust outlet 38, and submersion is determined (step S8). When submersion is determined, EGR control at the time of submersion is performed next (step S10). Here, more specifically, EGR control using the map illustrated in FIG. 4 is performed.

In this way, according to the EGR device of the first embodiment, it becomes possible to effectively restrain excessive EGR by the exhaust outlet 38 of the exhaust passage 30 being submerged in water, and combustion instability with this.

The system of the first embodiment of the present disclosure is described thus far, and the system of the first embodiment may be carried out by being modified as follows.

Although in the system of the aforementioned first embodiment, the device that performs so-called LPL-EGR that recirculates EGR gas to the upstream side of the compressor 22a is described, the present disclosure may be applied in the EGR device that performs HPL-EGR that recirculates the exhaust gas of the exhaust manifold 28 to the intake manifold 18. Further, the engine 10 is not limited to a spark-ignition type gasoline engine, and the present disclosure may be applied to the other internal combustion engines such as a diesel engine.

Further, in the system of the first embodiment described above, the running resistance f₂ is used as an index at the time of performing determination of submersion. However, the determination method of submersion is not limited to this, and such a configuration may be adopted, that directly detects a situation of water submersion by using a liquid-drop sensor and an optical sensor, for example. Further, a relation between an engine output power, an inclination angle of the vehicle, and a vehicle speed is stored in the map or the like in advance, and when the actual vehicle speed is lower than estimation, with respect to the vehicle speed corresponding to the present engine output power and inclination angle that are specified by the map, submersion may be determined. Furthermore, a configuration that determines submersion from information of an on-board camera that is loaded on the vehicle, and the configuration that determines submersion from external information such as map information and weather information may be adopted.

Further, although in the system of the aforementioned first embodiment, the EGR valve opening degree map is switched as the EGR control at the time of submersion, the EGR control at the time of submersion is not limited to this. That is, as long as the EGR valve is operated to the opening degree at the closing side with respect to the EGR valve opening degree at the normal time, such a configuration may be adopted that fully closes the EGR valve opening degree at the time of submersion, or such a configuration may be adopted that limits the EGR valve opening degree at a predetermined ratio, for example.

When the vehicle runs on an uphill road, it can be determined that there is no risk of the exhaust outlet 38 being submerged in water without being determined from the running resistance f₂. Thus, in the system of the first embodiment, in the case where the vehicle is detected as running on an uphill road by an inclination sensor or the like, the flow shifts to the processing in step S6 described above without performing submersion determination in step S4 described above, and normal EGR control may be performed. Thereby, it becomes possible to reduce a possibility of erroneous determination of submersion being performed.

When the vehicle reverses, there is the risk of the exhaust outlet 38 being suddenly submerged in water. Further, the necessity to recirculate the EGR gas is scarce at the time of the vehicle reversing. Thus, in the system of the first embodiment, the EGR valve 46 may be controlled to be fully closed when the vehicle reverses. Thereby, it becomes possible to prepare for sudden submersion at the time of reversing of the vehicle.

What is claimed is:

1. A control apparatus for an internal combustion engine, comprising:
an EGR passage that connects between an intake passage and an exhaust passage of the internal combustion engine;
an EGR valve that is provided in the EGR passage; and
an opening degree controller that controls an opening degree of the EGR valve based on an operating state of the internal combustion engine,
wherein the opening degree controller is programmed to
determine whether or not there is a possibility of an exhaust outlet of the exhaust passage being submerged in water, and
control the opening degree of the EGR valve to a closing side when it is determined that there is the possibility of the exhaust outlet being submerged in water, as compared with a case where there is no possibility of the exhaust outlet being submerged in water in a same operating state.

2. The control apparatus for an internal combustion engine according to claim 1,
wherein the opening degree controller is programmed to calculate running resistance of a vehicle that is loaded with the internal combustion engine, and determines that there is the possibility of the exhaust outlet being submerged in water when the running resistance is a threshold value or more.

3. The control apparatus for an internal combustion engine according to claim 1,
wherein the opening degree controller is programmed to operate the opening degree of the EGR valve to full closure when it is determined that there is the possibility of the exhaust outlet being submerged in water.
